(19) United States
(12) Patent Application Publication
(10) Pub. No.: US 2026/0093058 A1
(43) Pub. Date: Apr. 2, 2026

(54) LIGHT-TRANSMITTING PRIVACY PROTECTION DEVICE

(71) Applicant: Century Technology (ShenZhen) Corp.,LTD, Shen-zhen (CN)

(72) Inventors: Chih-Chung LIU, Shen-zhen (CN); Hui WANG, Shen-zhen (CN); Yu-Xi QIAO, Shen-zhen (CN); Yuan XIONG, Shen-zhen (CN); Wen-Lin CHEN, Shen-zhen (CN); Meng-Chieh TAI, Shen-zhen (CN)

(21) Appl. No.: 19/328,459

(22) Filed: Sep. 15, 2025

(30) Foreign Application Priority Data
Sep. 30, 2024 (CN) 202411384487.8

(51) Int. Cl. G02B 5/00

(52) U.S. Cl. CPC G02B 5/005

(57) ABSTRACT

A light-transmitting privacy protection device, comprising a light-transmitting layer, a filling layer, and a plurality of privacy protection gratings. The filling layer is disposed on one surface of the light-transmitting layer. The plurality of privacy protection gratings are disposed within the filling layer and spaced apart along a first direction. Each of the privacy protection gratings includes a plurality of light-blocking structures, and the plurality of light-blocking structures are spaced apart along a second direction and a third direction. The first direction, second direction, and third direction are mutually orthogonal. A top surface and a bottom surface of each light-blocking structure are parallel to the surface of the light-transmitting layer, and the bottom surface of each light-blocking structure faces the surface of the light-transmitting layer.

### CROSS-REFERENCE TO RELATED APPLICATION

This application claims priority to Chinese Patent Application No. CN 202411384487.8 filed on Sep. 30, 2024, the disclosures of which are incorporated herein in their entirety by reference.

### TECHNICAL FIELD

The present application relates to a light-transmitting privacy protection device with privacy protection, light-blocking, and heat insulation functions.

### BACKGROUND

With the development of technology, electronic products such as smartphones and tablet computers have become indispensable personal items in modern life. However, when a user operates an electronic device equipped with a display in a public place, any passerby can view the content displayed on the device, thereby compromising the user's privacy.

Additionally, most existing automobiles use heat insulation films as a means of light-blocking and heat insulation for the front, rear, and side windows. However, when the heat insulation film is adhered to the glass, small gaps may form between the film and the glass, leading to the formation of air bubbles, which in turn degrades the light-blocking and heat insulation performance of the film.

### SUMMARY

In view of the above, the inventors propose a light-transmitting privacy protection device to replace the glass screen of electronic device displays or the front/rear/side windows of vehicles, thereby achieving privacy protection, light-blocking, and heat insulation functions.

In some embodiments, the light-transmitting privacy protection device includes a light-transmitting layer, a filling layer, and a plurality of privacy protection gratings. The filling layer is disposed on one surface of the light-transmitting layer. The plurality of privacy protection gratings are disposed within the filling layer and are spaced apart along a first direction. Each of the privacy protection gratings includes a plurality of light-blocking structures. The plurality of light-blocking structures are spaced apart along a second direction and a third direction. The first direction, second direction, and third direction are mutually orthogonal. The top surface and bottom surface of each light-blocking structure are parallel to the surface of the light-transmitting layer, and the bottom surface of each light-blocking structure faces the surface of the light-transmitting layer.

In some embodiments, each light-blocking structure is trapezoidal, and the area of the top surface of each light-blocking structure is smaller than the area of the bottom surface of each light-blocking structure.

In some embodiments, the height of each light-blocking structure is smaller than the distance between two adjacent rows in the privacy protection gratings.

In some embodiments, the width of each light-blocking structure is smaller than the distance between two adjacent privacy protection gratings.

In some embodiments, the distance between two adjacent rows in the privacy protection gratings is smaller than the distance between two adjacent privacy protection gratings.

The inventors propose another light-transmitting privacy protection device. In some embodiments, the other light-transmitting privacy protection device includes a light-transmitting layer, a filling layer, and a plurality of privacy protection gratings. The filling layer is disposed on one surface of the light-transmitting layer. The plurality of privacy protection gratings are disposed within the filling layer and are spaced apart along a first direction. Each of the privacy protection gratings includes a plurality of first light-blocking structures and a plurality of second light-blocking structures. The plurality of first light-blocking structures are spaced apart along a second direction, forming a first array. The plurality of second light-blocking structures are spaced apart along both the second direction and a third direction, forming a second array. The first direction, second direction, and third direction are mutually orthogonal. The projection of each first light-blocking structure in each row of the privacy protection gratings onto the surface fully overlaps with the partial projection of each second light-blocking structure in each row of the privacy protection gratings onto the surface.

In some embodiments, the distance between the first array and the second array is greater than the distance between two adjacent rows in the second array.

In some embodiments, the distance between two adjacent rows in the second array is smaller than the distance between two adjacent privacy protection gratings.

In some embodiments, the height of each second light-blocking structure is smaller than the distance between two adjacent rows in the second array.

In some embodiments, the width of each second light-blocking structure is smaller than the distance between two adjacent privacy protection gratings.

In summary, according to any of the embodiments described above, the light-transmitting privacy protection device is equipped with a plurality of light-blocking structures arranged in a spaced-apart manner to block light, thereby achieving privacy protection, light-blocking, and heat insulation functions. Furthermore, the light-transmitting privacy protection device can adjust its parameters (such as privacy protection rate, light-blocking rate, and heat insulation rate) by altering the size of the light-blocking structures and/or the distance between adjacent light-blocking structures, enabling the selection of a corresponding set of parameters suitable for various usage scenarios.

### BRIEF DESCRIPTION OF THE DRAWINGS

The drawings are used for better understanding of the present invention, but not intended to limit the scope of the present invention.

FIG. 1 is a perspective view of the light-transmitting privacy protection device according to a first embodiment.

FIG. 2 is a top plan view of the light-transmitting privacy protection device shown in FIG. 1.

FIG. 3 is a cross-sectional view of the light-transmitting privacy protection device according to the first exemplary embodiment, taken along section line 1-1 of FIG. 1.

FIG. 4 is a cross-sectional view of the light-transmitting privacy protection device according to the first exemplary embodiment, taken along section line 2-2 of FIG. 1.

FIG. 5 is a cross-sectional view of the light-transmitting privacy protection device according to a second exemplary embodiment of FIG. 1.

FIG. 6 is a cross-sectional view of the light-transmitting privacy protection device according to a third exemplary embodiment of FIG. 1.

FIG. 7 is a cross-sectional view of the light-transmitting privacy protection device according to a fourth exemplary embodiment of FIG. 1.

FIG. 8 is a perspective view of the light-transmitting privacy protection device according to a second embodiment.

FIG. 9 is a top plan view of the light-transmitting privacy protection device shown in FIG. 8.

FIG. 10 is a perspective view of the light-transmitting privacy protection device according to a third embodiment.

FIG. 11 is a top plan view of the light-transmitting privacy protection device shown in FIG. 10.

FIG. 12 is a cross-sectional view of the light-transmitting privacy protection device shown in FIG. 8, taken along section line 3-3.

FIG. 13 is a cross-sectional view of the light-transmitting privacy protection device shown in FIG. 10, taken along section line 5-5.

FIG. 14 is a cross-sectional view of the light-transmitting privacy protection device shown in FIG. 8 (or FIG. 10), taken along section line 4-4 (or section line 6-6).

Wherein, the numerals and symbols used in the drawings are listed as following.
2: Light-transmitting privacy protection device
20: Light-transmitting layer
21: Filling layer
22: Privacy protection grating
220: Light-blocking structure
221: Light-blocking structure
222: Light-blocking structure
D1: Distance
D2: Distance
D3: Distance
H0: Height
H2: Height
LT1: Light ray
LT1′: Light ray
LT2: Light ray
LT2′: Light ray
LT3: Light ray
LT4: Light ray
LTM: Light ray
P1: Position
SB: Bottom surface
SF: Surface
ST: Top surface
W0: Width
W1: Width
W2: Width

### DETAILED DESCRIPTION OF DISCLOSED EMBODIMENTS

With respect to the terminology used herein, it should be understood that the term “comprising” is an open-ended term and should be interpreted as “including but not limited to”; the terms “disposed on” or “positioned on” refer to two or more components being in either “direct” physical or electrical contact with each other or in “indirect” physical or electrical contact with each other; and the terms “a,” “another,” “first,” “second,” and “third,” are used to distinguish the components being referenced, and unless specifically indicated otherwise, are not intended to imply any particular order or limitation on the scope of the invention.

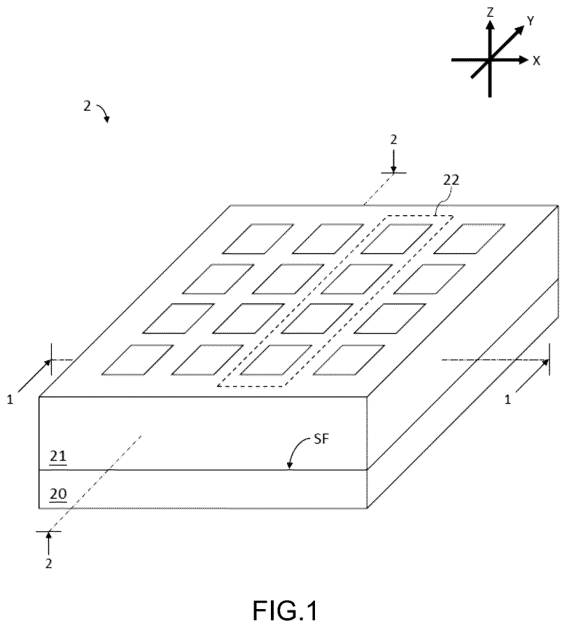

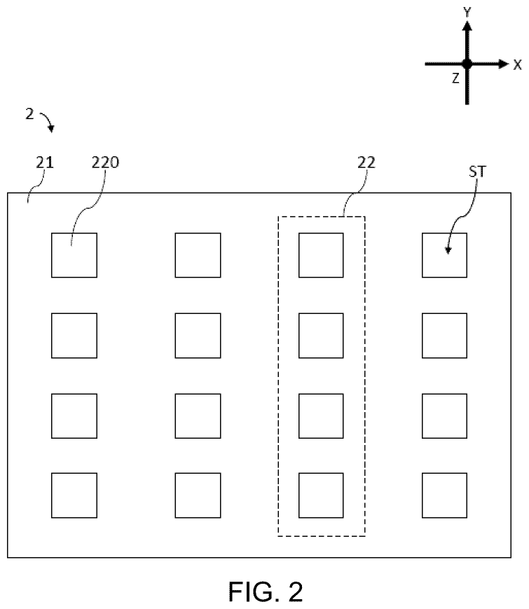

Referring to FIG. 1 and FIG. 2, FIG. 1 is a perspective view of the light-transmitting privacy protection device 2 according to a first embodiment, and FIG. 2 is a top plan view of the light-transmitting privacy protection device 2 shown in FIG. 1. A light-transmitting privacy protection device 2 includes a light-transmitting layer 20, a filling layer 21, and a plurality of privacy protection gratings 22. The filling layer 21 is disposed on one surface SF of the light-transmitting layer 20, and the plurality of privacy protection gratings 22 are disposed within the filling layer 21 and are spaced apart along a first direction. Taking FIG. 1 and FIG. 2 as an example, in this embodiment, the light-transmitting privacy protection device 2 includes four privacy protection gratings 22, and these four privacy protection gratings 22 are spaced apart along the first direction (corresponding to the X direction in a Cartesian coordinate system).

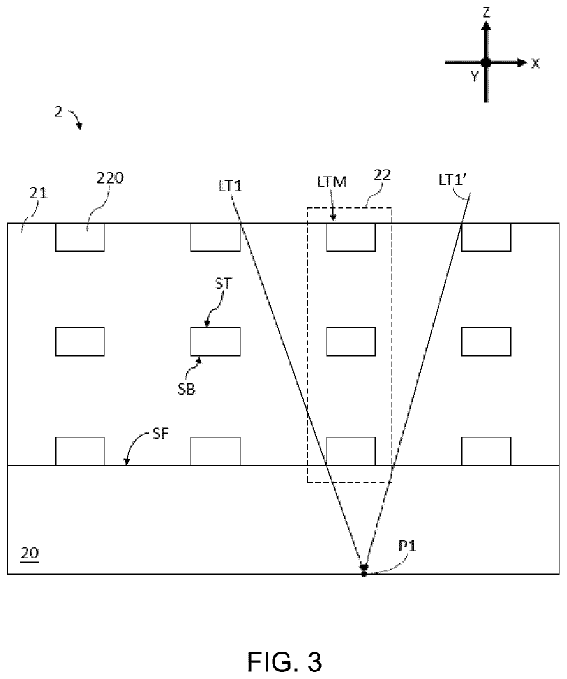

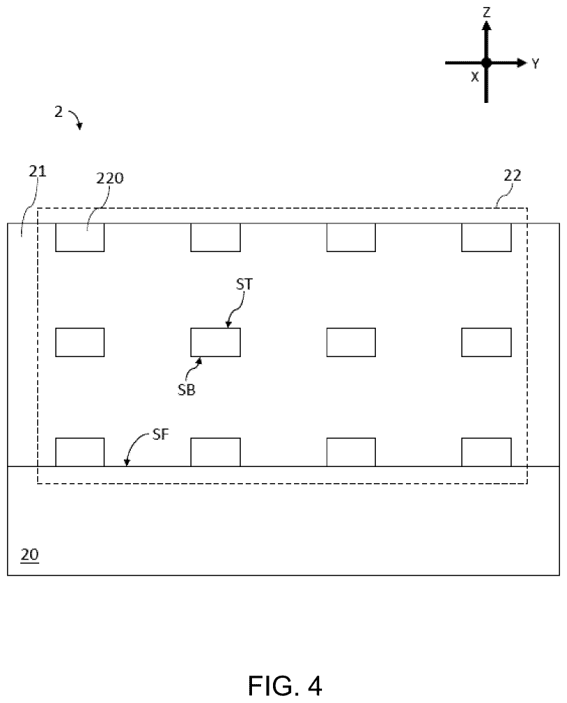

Referring further to FIG. 3 and FIG. 4, FIG. 3 is a cross-sectional view of the light-transmitting privacy protection device 2 according to the first exemplary embodiment, taken along section line 1-1 of FIG. 1, and FIG. 4 is a cross-sectional view of the light-transmitting privacy protection device 2 according to the first exemplary embodiment, taken along section line 2-2 of FIG. 1. In other words, FIG. 3 is a front cross-sectional view of the light-transmitting privacy protection device 2 shown in FIG. 1, and FIG. 4 is a side cross-sectional view of the light-transmitting privacy protection device 2 shown in FIG. 1. In some embodiments, each privacy protection grating 22 includes a plurality of light-blocking structures 220, and the plurality of light-blocking structures 220 are spaced apart along a second direction and a third direction. Taking FIG. 3 and FIG. 4 as an example, in this embodiment, each privacy protection grating 22 includes 12 light-blocking structures, and these 12 light-blocking structures are spaced apart along the second direction (corresponding to the Y direction in the Cartesian coordinate system) and the third direction (corresponding to the Z direction in the Cartesian coordinate system). In some embodiments, the first direction (corresponding to the X direction), the second direction (corresponding to the Y direction), and the third direction (corresponding to the Z direction) are mutually orthogonal.

In some embodiments, each light-blocking structure 220 may be a rectangular body (as shown in FIGS. 1 to 4). Furthermore, in some embodiments, the light-blocking structures 220 are used to block part of the light entering the light-transmitting privacy protection device 2. Taking FIG. 3 as an example, in this embodiment, when a user's line of sight is positioned at a location P1 within the light-transmitting privacy protection device 2, the maximum range of light that the user can receive at location P1 is between light rays LT1 and LT1′ (hereinafter referred to as a first range). It should be noted that due to the influence of the light-blocking structures 220, the user at location P1 may not receive all the light within the first range. For example, although light ray LTM is located within the first range between light rays LT1 and LT1′ as shown in FIG. 3, light ray LTM will still be blocked by the light-blocking structure 220, preventing the user at location P1 from receiving light ray LTM.

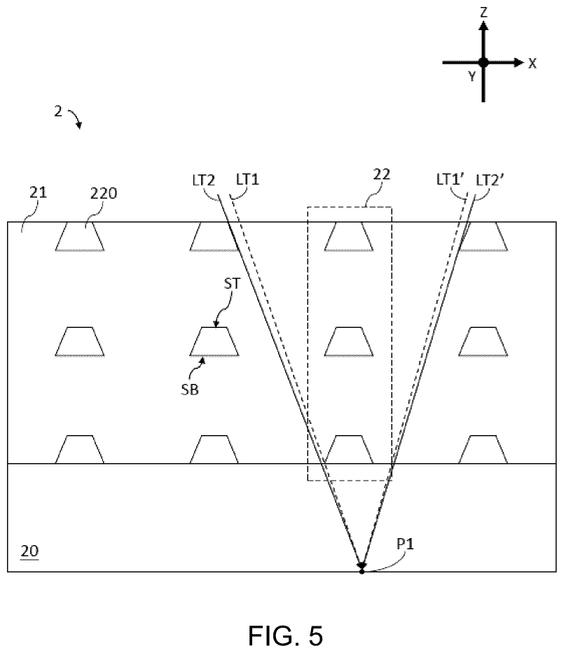

Please further refer to FIG. 5, which is a cross-sectional view of the light-transmitting privacy protection device 2 according to the second exemplary embodiment (corresponding to FIG. 3). As shown in FIG. 5, in some embodiments, each light-blocking structure 220 may be trapezoidal, and the area of the top surface ST of each light-blocking structure 220 is smaller than the area of the bottom surface SB of each light-blocking structure 220. In other words, the side length of the top surface ST of each light-blocking structure 220 is smaller than the side length of the bottom surface SB of each light-blocking structure 220.

In some embodiments, when the area of the bottom surface SB of the trapezoidal light-blocking structure 220 is equal to the area of the bottom surface SB of the rectangular light-blocking structure 220, the trapezoidal light-blocking structure 220 allows more light to enter the light-transmitting privacy protection device 2 (compared to the rectangular light-blocking structure 220). Taking FIG. 5 as an example, in this embodiment, when the user's line of sight is positioned at location P1 within the light-transmitting privacy protection device 2, the maximum range of light that the user can receive at location P1 is between light rays LT2 and LT2′ (hereinafter referred to as a second range), and the second range between light rays LT2 and LT2′ is greater than the first range between light rays LT1 and LT1′ (as shown in FIG. 5). In this manner, the user can adjust the privacy protection rate, light-blocking rate, and heat insulation rate of the light-transmitting privacy protection device 2 by changing the shape of each light-blocking structure 220.

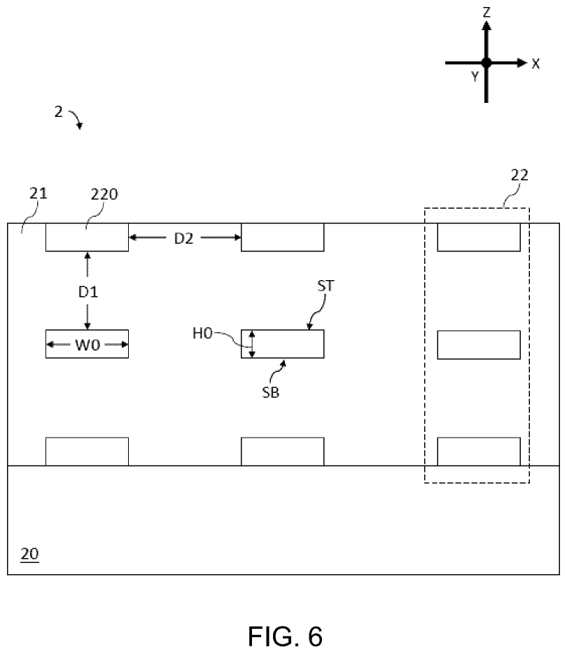

Please further refer to FIG. 6, which is a cross-sectional view of the light-transmitting privacy protection device 2 according to the third exemplary embodiment (corresponding to FIG. 3). As shown in FIG. 6, in some embodiments, the height H0 of each light-blocking structure 220 is smaller than the distance D1 between two adjacent rows in each privacy protection grating 22. In these embodiments, as the height H0 of each light-blocking structure 220 increases, the privacy protection rate, light-blocking rate, and heat insulation rate of the light-transmitting privacy protection device 2 also increase, while the visible range decreases. Additionally, as the distance D1 between two adjacent rows in each privacy protection grating 22 increases, the privacy protection rate, light-blocking rate, and heat insulation rate of the light-transmitting privacy protection device 2 decrease, while the visible range increases. In this regard, when the height H0 of each light-blocking structure 220 is smaller than the distance D1 between two adjacent rows in each privacy protection grating 22, the light-transmitting privacy protection device 2 can ensure sufficient privacy protection rate, light-blocking rate, and heat insulation rate while maintaining an adequate visible range.

Furthermore, in some embodiments, the width W0 of each light-blocking structure 220 is smaller than the distance D2 between two adjacent privacy protection gratings 22 in the light-transmitting privacy protection device 2. In these embodiments, as the width W0 of each light-blocking structure 220 increases, the privacy protection rate, light-blocking rate, and heat insulation rate of the light-transmitting privacy protection device 2 increase, while the visible range decreases. Additionally, as the distance D2 between two adjacent privacy protection gratings 22 in the light-transmitting privacy protection device 2 increases, the privacy protection rate, light-blocking rate, and heat insulation rate decrease, while the visible range increases. In this regard, when the width W0 of each light-blocking structure 220 is smaller than the distance D2 between two adjacent privacy protection gratings 22 in the light-transmitting privacy protection device 2, the device can ensure sufficient privacy protection rate, light-blocking rate, and heat insulation rate while maintaining an adequate visible range.

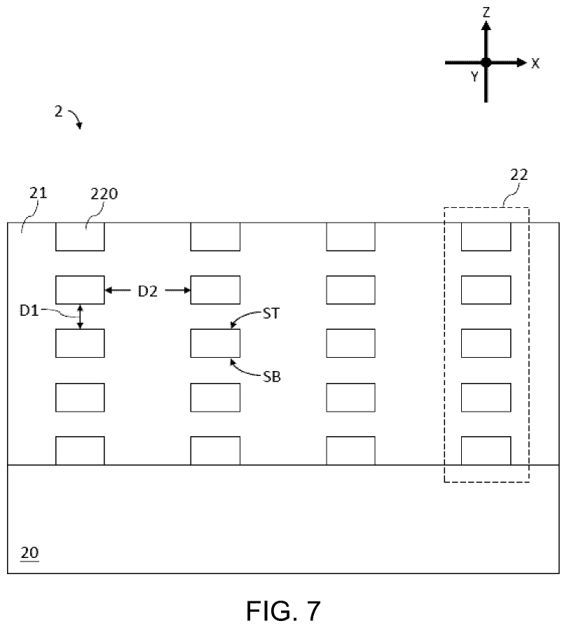

Please further refer to FIG. 7, which is a cross-sectional view of the light-transmitting privacy protection device 2 according to the fourth exemplary embodiment (corresponding to FIG. 3). As shown in FIG. 7, in some embodiments, the distance D1 between two adjacent rows in each privacy protection grating 22 is smaller than the distance D2 between two adjacent privacy protection gratings 22 in the light-transmitting privacy protection device 2. In these embodiments, as the distance D1 between two adjacent rows in each privacy protection grating 22 increases, the privacy protection rate, light-blocking rate, and heat insulation rate of the light-transmitting privacy protection device 2 decrease, while the visible range increases. Additionally, as the distance D2 between two adjacent privacy protection gratings 22 in the light-transmitting privacy protection device 2 increases, the privacy protection rate, light-blocking rate, and heat insulation rate decrease, while the visible range increases. Accordingly, when the distance D1 between two adjacent rows in each privacy protection grating 22 is smaller than the distance D2 between two adjacent privacy protection gratings 22 in the light-transmitting privacy protection device 2, the device can ensure sufficient privacy protection rate, light-blocking rate, and heat insulation rate while maintaining an adequate visible range.

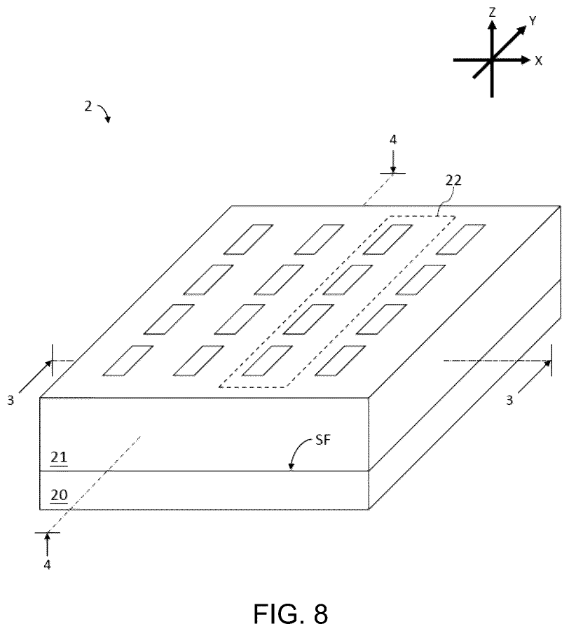

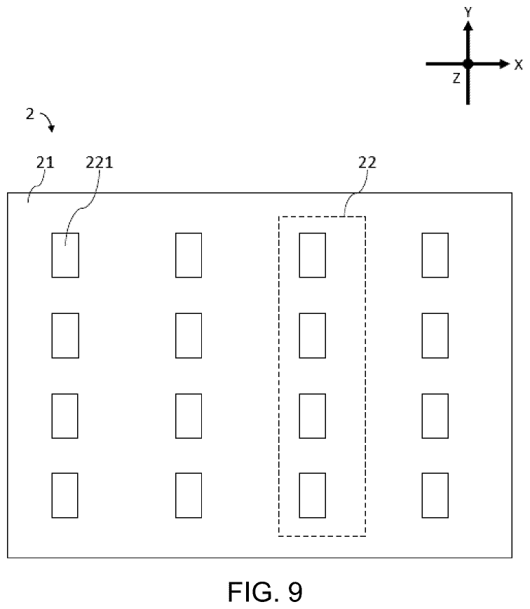

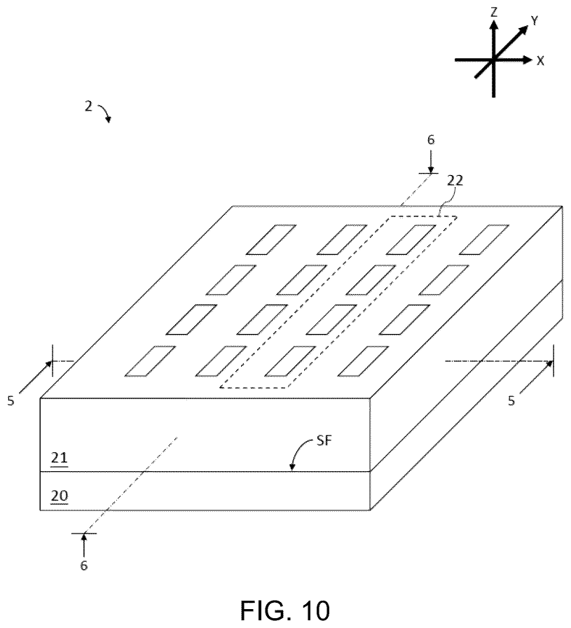

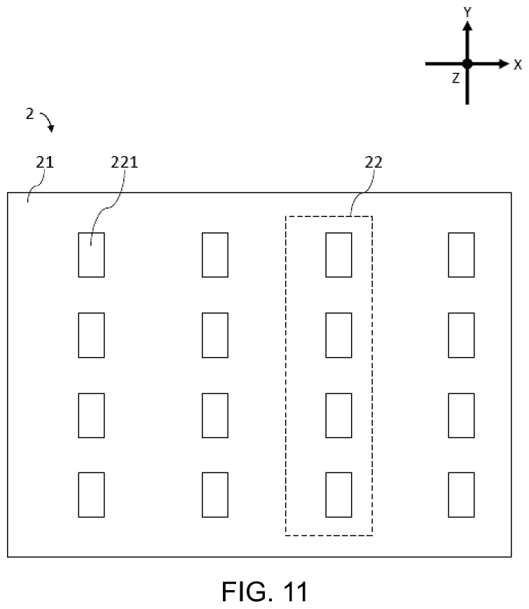

Please refer to FIGS. 8 to 11. FIGS. 8 and 9 are a perspective view and a top plan view, respectively, of the light-transmitting privacy protection device 2 according to the second embodiment, and FIGS. 10 and 11 are a perspective view and a top plan view, respectively, of the light-transmitting privacy protection device 2 according to the third embodiment. Another light-transmitting privacy protection device 2 includes a light-transmitting layer 20, a filling layer 21, and a plurality of privacy protection gratings 22. The filling layer 21 is disposed on one surface SF of the light-transmitting layer 20, and the plurality of privacy protection gratings 22 are disposed within the filling layer 21 and are spaced apart along a first direction. Taking FIGS. 8 and 10 as examples, in some embodiments, the light-transmitting privacy protection device 2 includes four privacy protection gratings 22, and these four privacy protection gratings 22 are spaced apart along the first direction (corresponding to the X direction in a Cartesian coordinate system).

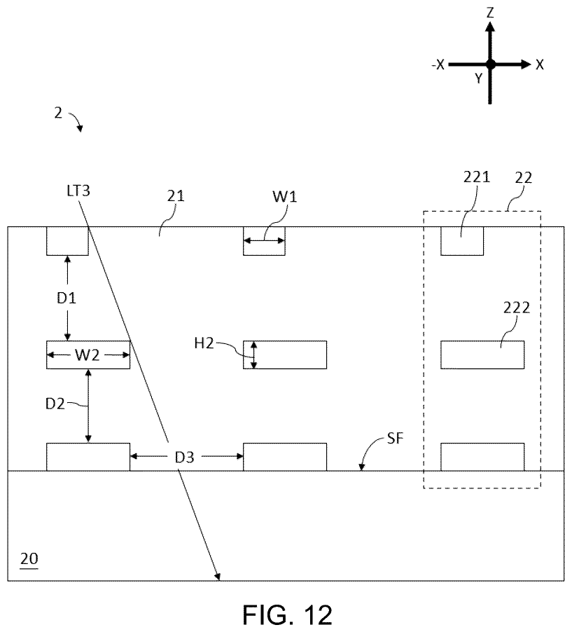

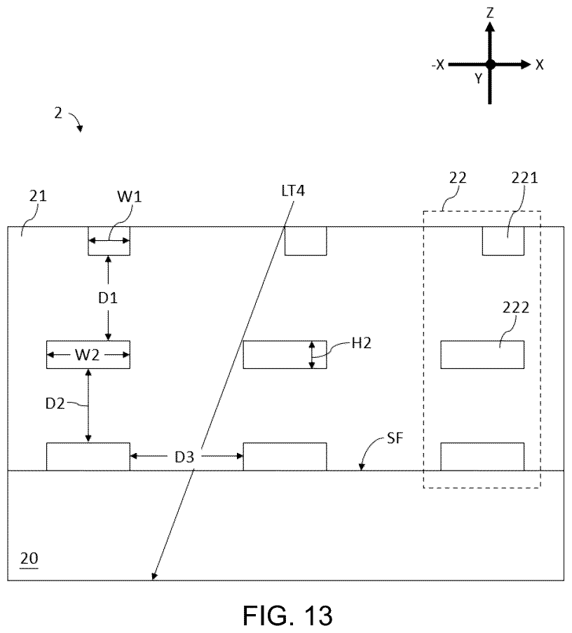

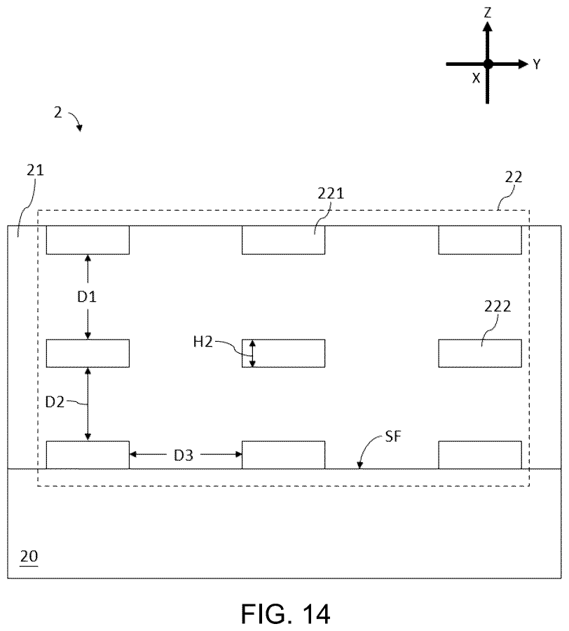

Please further refer to FIGS. 12 to 14. FIGS. 12 and 13 are cross-sectional views of the light-transmitting privacy protection device 2 shown in FIGS. 8 and 10, respectively, taken along section lines 3-3 and 5-5. FIG. 14 is a cross-sectional view of the light-transmitting privacy protection device 2 shown in FIG. 8 (or FIG. 10), taken along section line 4-4 (or section line 6-6). In other words, FIGS. 12 and 13 are front cross-sectional views of the light-transmitting privacy protection device 2 shown in FIGS. 8 and 10, respectively, and FIG. 14 is a side cross-sectional view of the light-transmitting privacy protection device 2 shown in FIG. 8 or FIG. 10. In some embodiments, each privacy protection grating 22 includes a plurality of light-blocking structures 221 (hereinafter referred to as “first light-blocking structures 221”) and a plurality of other light-blocking structures 222 (hereinafter referred to as “second light-blocking structures 222”). The plurality of first light-blocking structures 221 are spaced apart along a second direction to form a first array, and the plurality of second light-blocking structures 222 are spaced apart along both the second direction and a third direction to form a second array.

Taking FIGS. 12 to 14 as examples, in this embodiment, each privacy protection grating 22 includes three first light-blocking structures 221 and six second light-blocking structures 222. The three first light-blocking structures 221 are spaced apart along the second direction (corresponding to the Y direction in the Cartesian coordinate system) to form the first array, and the six second light-blocking structures 222 are spaced apart along the second direction (corresponding to the Y direction) and the third direction (corresponding to the Z direction in the Cartesian coordinate system) to form the second array. In some embodiments, the first direction (corresponding to the X direction), the second direction (corresponding to the Y direction), and the third direction (corresponding to the Z direction) are mutually orthogonal.

In some embodiments, the complete projection of each first light-blocking structure 221 in each row of the privacy protection grating 22 on the surface SF overlaps with the partial projection of the plurality of second light-blocking structures 222 in each row of the privacy protection grating 22 on the surface SF. Taking FIG. 12 as an example, in this embodiment, the complete projection of the first light-blocking structures 221 in the privacy protection grating 22 on the surface SF overlaps with the left half of the projection of the plurality of second light-blocking structures 222 in the privacy protection grating 22 on the surface SF, where the left half corresponds to the −X direction in the Cartesian coordinate system. Thus, the light-transmitting privacy protection device 2 shown in FIG. 12 can receive light rays LT3 from the left side (corresponding to the −X direction). Similarly, taking FIG. 13 as an example, in this embodiment, the complete projection of the first light-blocking structures 221 in the privacy protection grating 22 on the surface SF overlaps with the right half of the projection of the plurality of second light-blocking structures 222 in the privacy protection grating 22 on the surface SF, where the right half corresponds to the X direction in the Cartesian coordinate system. Thus, the light-transmitting privacy protection device 2 shown in FIG. 13 can receive light rays LT4 from the right side (corresponding to the X direction).

In some embodiments, the user can adjust the size of the first light-blocking structures 221 and the second light-blocking structures 222 to modify the ratio between the complete projection of the first light-blocking structures 221 on the surface SF and the complete projection of the second light-blocking structures 222 on the surface SF, thereby adjusting the range of light that the light-transmitting privacy protection device 2 can receive. For example, when the ratio is 30%, it means that the projection area of the first light-blocking structures 221 on the surface SF is 30% of the projection area of the second light-blocking structures 222 on the surface SF. As another example, when the ratio is 70%, it means that the projection area of the first light-blocking structures 221 on the surface SF is 70% of the projection area of the second light-blocking structures 222 on the surface SF. In this case, the range of light that the light-transmitting privacy protection device 2 with a 30% ratio can receive will be larger than the range of light that the light-transmitting privacy protection device 2 with a 70% ratio can receive.

As shown in FIGS. 12 to 14, in some embodiments, the distance D1 between the first array and the second array in each privacy protection grating 22 is greater than the distance D2 between two adjacent rows in the second array. Since the width W1 of each first light-blocking structure 221 is smaller than the width W2 of each second light-blocking structure 222, the light-transmitting privacy protection device 2 can receive light from the X direction or −X direction (such as light rays LT3 shown in FIG. 12 and light rays LT4 shown in FIG. 13). The user can adjust the distance D1 between the first array and the second array to modify the range of light that the light-transmitting privacy protection device 2 can receive, thereby adjusting the visible range of the light-transmitting privacy protection device 2. When the distance D1 between the first array and the second array in each privacy protection grating 22 is greater than the distance D2 between two adjacent rows in the second array, the range of light received from the left side (corresponding to the −X direction) or the right side (corresponding to the X direction) increases, thereby expanding the visible range of the light-transmitting privacy protection device 2.

As shown in FIGS. 12 to 14, in some embodiments, the distance D2 between two adjacent rows in the second array in each privacy protection grating 22 is smaller than the distance D3 between two adjacent privacy protection gratings 22. As the distance D2 between two adjacent rows in the second array in each privacy protection grating 22 increases, the privacy protection rate, light-blocking rate, and heat insulation rate of the light-transmitting privacy protection device 2 decrease, while the visible range increases. Additionally, as the distance D3 between two adjacent privacy protection gratings 22 in the light-transmitting privacy protection device 2 increases, the privacy protection rate, light-blocking rate, and heat insulation rate decrease, while the visible range increases. Therefore, when the distance D2 between two adjacent rows in the second array in each privacy protection grating 22 is smaller than the distance D3 between two adjacent privacy protection gratings 22 in the light-transmitting privacy protection device 2, the device can ensure a sufficient privacy protection rate, light-blocking rate, and heat insulation rate while maintaining an adequate visible range.

As shown in FIGS. 12 to 14, in some embodiments, the height H2 of each second light-blocking structure 222 is smaller than the distance D2 between two adjacent rows in the second array. As the height H2 of each second light-blocking structure 222 increases, the privacy protection rate, light-blocking rate, and heat insulation rate of the light-transmitting privacy protection device 2 increase, while the visible range decreases. Additionally, as the distance D3 between two adjacent privacy protection gratings 22 in the light-transmitting privacy protection device 2 increases, the privacy protection rate, light-blocking rate, and heat insulation rate decrease, while the visible range increases. Therefore, when the height H2 of each second light-blocking structure 222 is smaller than the distance D2 between two adjacent rows in the second array, the light-transmitting privacy protection device 2 can ensure a sufficient privacy protection rate, light-blocking rate, and heat insulation rate while maintaining an adequate visible range.

As shown in FIGS. 12 to 14, in some embodiments, the width W2 of each second light-blocking structure 222 is smaller than the distance D3 between two adjacent privacy protection gratings 22 in the light-transmitting privacy protection device 2. As the width W2 of each second light-blocking structure 222 increases, the privacy protection rate, light-blocking rate, and heat insulation rate of the light-transmitting privacy protection device 2 also increase, while the visible range decreases. Furthermore, as the distance D3 between two adjacent privacy protection gratings 22 in the light-transmitting privacy protection device 2 increases, the privacy protection rate, light-blocking rate, and heat insulation rate decrease, while the visible range increases. Therefore, when the width W2 of each second light-blocking structure 222 is smaller than the distance D3 between two adjacent privacy protection gratings 22 in the light-transmitting privacy protection device 2, the device can ensure sufficient privacy protection rate, light-blocking rate, and heat insulation rate while maintaining an adequate visible range.

In some embodiments, the material of the light-transmitting layer 20 may be a hard, light-transmitting material, such as but not limited to glass or acrylic. In other embodiments, the material of the light-transmitting layer 20 may be a hard, light-transmitting, and ultraviolet-resistant material, such as but not limited to polycarbonate (PC) or polymethyl methacrylate (PMMA).

In some embodiments, the material of the filling layer 21 may be a light-transmitting material, such as but not limited to silicone, epoxy, polyimide (PI), benzocyclobutene (BCB), perfluorocyclobutyl (PFCB), 8 epoxy groups (SU8), acrylic resin, polyethylene terephthalate (PET), or polyetherimide (PEI). In other embodiments, the material of the filling layer 21 may be a transparent adhesive material, such as but not limited to adhesives, underfill, anisotropic conductive paste (ACP), anisotropic conductive film (ACF), non-conductive paste (NCP), or non-conductive film (NCF).

In some embodiments, the material of the light-blocking structures 220/221/222 may be a black matrix (BM) material. In other embodiments, the material of the light-blocking structures 220/221/222 may be a light-reflective material, such as but not limited to metal, alumina, dielectric multilayer film, or reflective resin materials.

In summary, according to any of the above embodiments, the light-transmitting privacy protection device is provided with a plurality of light-blocking structures arranged at intervals to block light, thereby achieving privacy protection, light-blocking, and heat insulation functions. Furthermore, the light-transmitting privacy protection device can adjust its parameters (such as privacy protection rate, light-blocking rate, and heat insulation rate) by changing the size of the light-blocking structures and/or the distance between adjacent light-blocking structures, allowing the selection of a corresponding set of parameters suitable for various usage scenarios.

What is claimed is:

1. A light-transmitting privacy protection device, comprising:
a light-transmitting layer;
a filling layer disposed on one surface of the light-transmitting layer; and
a plurality of privacy protection gratings disposed within the filling layer and spaced apart along a first direction, wherein each privacy protection grating comprises:
a plurality of light-blocking structures spaced apart along a second direction and a third direction;
wherein the first direction, the second direction, and the third direction are orthogonal to each other; and a top surface and a bottom surface of each light-blocking structure are parallel to the surface of the light-transmitting layer, with the bottom surface of each light-blocking structure facing the surface of the light-transmitting layer.

2. The light-transmitting privacy protection device according to claim 1, wherein each light-blocking structure is trapezoidal, and the area of the top surface of each light-blocking structure is smaller than the area of the bottom surface of each light-blocking structure.

3. The light-transmitting privacy protection device according to claim 1, wherein the height of each light-blocking structure is smaller than the distance between two adjacent rows of the privacy protection gratings.

4. The light-transmitting privacy protection device according to claim 1, wherein the width of each light-blocking structure is smaller than the distance between two adjacent privacy protection gratings.

5. The light-transmitting privacy protection device according to claim 1, wherein the distance between two adjacent rows of each privacy protection grating is smaller than the distance between two adjacent privacy protection gratings.

6. A light-transmitting privacy protection device, comprising:
a light-transmitting layer;
a filling layer disposed on one surface of the light-transmitting layer; and
a plurality of privacy protection gratings disposed within the filling layer and spaced apart along a first direction, wherein each privacy protection grating comprises:
a plurality of first light-blocking structures spaced apart along a second direction to form a first array; and
a plurality of second light-blocking structures spaced apart along the second direction and a third direction to form a second array;
wherein the first direction, the second direction, and the third direction are orthogonal to each other; and the complete projection of each first light-blocking structure in each row of the privacy protection gratings on the surface overlaps with the partial projection of the plurality of second light-blocking structures in each row of the privacy protection gratings on the surface.

7. The light-transmitting privacy protection device according to claim 6, wherein the distance between the first array and the second array is greater than the distance between two adjacent rows in the second array.

8. The light-transmitting privacy protection device according to claim 6, wherein the distance between two adjacent rows in the second array is smaller than the distance between two adjacent privacy protection gratings.

9. The light-transmitting privacy protection device according to claim 6, wherein the height of each second light-blocking structure is smaller than the distance between two adjacent rows in the second array.

10. The light-transmitting privacy protection device according to claim 6, wherein the width of each second light-blocking structure is smaller than the distance between two adjacent privacy protection gratings.
